(19) United States
(12) Patent Application Publication
(10) Pub. No.: US 2006/0058022 A1
(43) Pub. Date: Mar. 16, 2006

(54) Systems and methods for calibrating transmission of an antenna array

(76) Inventors: Mark Webster, Indian Harbor Beach, FL (US); Daniel Shearer, Scottsdale, AZ (US); Steven Halford, Palm Bay, FL (US); Bruce Cochran, Mesa, AZ (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/215,563

(22) Filed: Aug. 29, 2005

Related U.S. Application Data
(60) Provisional application No. 60/604,942, filed on Aug. 27, 2004.

(51) Int. Cl. H04B 17/00; H04Q 7/20

(52) U.S. Cl. 455/423; 455/67.11

(57) ABSTRACT

Disclosed herein are various embodiments of methods, systems, and apparatuses for sending and receiving signals in a digital communication system. In one embodiment performs steps of transmitting a signal from a device with a first antenna array and calibrating the signal with a phase shift of the signal. In one exemplary method embodiment, a signal is transmitted from a beam-forming transmitter to an assisting receiver in an IEEE 802.11 wireless transmission. A return calibration signal from the assisting receiver with information regarding the phase error of signal is received by the beam-forming transceiver. The beam-forming transmitter introduces a calibration phase error to cancel the phase error as reported by the assisting receiver.

### CROSS-REFERENCE TO RELATED APPLICATION

This application claims priority to copending U.S. provisional application having Ser. No. 60/604,942, filed Aug. 27, 2004, which is entirely incorporated herein by reference.

### 1. FIELD OF THE INVENTION

The present invention is generally related to digital communications and, more particularly, is related to systems and methods for calibrating a beam-forming transmitter to counteract phase errors.

### 2. RELATED ART

Communication networks come in a variety of forms. Notable networks include wireline and wireless. Wireline networks include local area networks (LANs), DSL networks, and cable networks, among others. Wireless networks include cellular telephone networks, classic land mobile radio networks and satellite transmission networks, among others. These wireless networks are typically characterized as wide area networks. More recently, wireless local area networks and wireless home networks have been proposed, and standards, such as Bluetooth and IEEE 802.11, have been introduced to govern the development of wireless equipment for such localized networks.

A wireless local area network (LAN) typically uses infrared (IR) or radio frequency (RF) communications channels to communicate between portable or mobile computer terminals and stationary access points or base stations. These access points are, in turn, connected by a wired or wireless communications channel to a network infrastructure which connects groups of access points together to form the LAN, including, optionally, one or more host computer systems.

Wireless protocols such as Bluetooth and IEEE 802.11 support the logical interconnections of such portable roaming terminals having a variety of types of communication capabilities to host computers. The logical interconnections are based upon an infrastructure in which at least some of the terminals are capable of communicating with at least two of the access points when located within a predetermined range, each terminal being normally associated, and in communication, with a single one of the access points. Based on the overall spatial layout, response time, and loading requirements of the network, different networking schemes and communication protocols have been designed so as to most efficiently regulate the communications.

IEEE Standard 802.11 (“802.11”) is set out in “Wireless LAN Medium Access Control (MAC) and Physical Layer (PHY) Specifications” and is available from the IEEE Standards Department, Piscataway, N.J. IEEE 802.11 permits either IR or RF communications at 1 Mbps, 2 Mbps and higher data rates, a medium access technique similar to carrier sense multiple access/collision avoidance (CSMA/CA), a power-save mode for battery-operated mobile stations, seamless roaming in a full cellular network, high throughput operation, diverse antenna systems designed to eliminate “dead spots,” and an easy interface to existing network infrastructures.

The 802.11a standard defines data rates of 6, 12, 18, 24, 36 and 54 Mbps in the 5 GHz band. Demand for higher data rates may result in the need for devices that can communicate with each other at the higher rates, yet co-exist in the same WLAN environment or area without significant interference or interruption from each other, regardless of whether the higher data rate devices can communicate with the 802.11a devices. It may further be desired that high data rate devices be able to communicate with the 802.11a devices, such as at any of the standard 802.11 a rates.

One challenge in designing a wireless transmission system involves maximal ratio combining (MRC). MRC focuses a signal toward a receiver in such a way that it combines at the receiver resulting in a stronger signal. If a signal is transmitted off multiple antennas and focused or beam-formed toward a designated receiver rather than transmitting in an omni-directional fashion, the composite phase error of the transmission determines the effectiveness of the beam-forming. The phase relationship between the transmit antennas is calibrated to focus this energy in one designated direction. One way to calibrate a beam-forming transmitter is to incorporate additional circuitry on the radio. The circuitry senses the signal and compares it to a known signal. However, this solution can be expensive.

Increasing the effective signal strength and receiver sensitivity enables more efficient communications. Increased signal strength may enable service providers to more effectively use their equipment. Consumers may realize a cost savings as well.

### 3. SUMMARY

This disclosure describes systems and methods for calibrating beam-forming phase errors in a digital communication system. In one exemplary method embodiment, among others, a beam-forming transmitter transmits a signal with a array of antennas and calibrates with a phase shift of the signal. In an exemplary system embodiment, among others, a system targeted at a high-speed wireless local area network (LAN) standard includes an array of antennas and a processor configured to prepare a signal for transmission with the array of antennas and to calibrate with a phase shift of the signal.

Other systems, methods, features and advantages of the disclosure will be or will become apparent to one with skill in the art upon examination of the following figures and detailed description. It is intended that all such additional systems, methods, features and advantages be included within this description, be within the scope of the invention, and be protected by the accompanying claims.

### 4. BRIEF DESCRIPTION OF THE DRAWINGS

The components in the figures are not necessarily to scale, emphasis instead being placed upon illustrating the principles of the disclosed systems and methods. In the figures, like reference numerals designate corresponding parts throughout the different views.

FIG. 1 is a block diagram illustrating an International Organization for Standards (ISO) Basic Reference Model of open systems interconnection (OSI).

FIG. 2 is a block diagram of transmit maximal ratio combining (MRC) in which a signal is focused at a designated receiver.

FIG. 3 provides a block diagram of the phase errors introduced throughout a transmit path using the MRC process of FIG. 2.

FIG. 4 provides a block diagram of an exemplary embodiment of a radio using the MRC process of FIG. 2.

FIG. 5 is a block diagram of a type 1 radio using the MRC process of FIG. 2.

FIG. 6 provides a block diagram of a type 2 radio using the MRC process of FIG. 2.

FIG. 7 provides a timing diagram of an IEEE 802.11 packet using the MRC process of FIG. 2.

FIGS. 8A and 8B provide block diagrams of a demuxing technique from a transmitter using the MRC process of FIG. 2.

FIGS. 9A and 9B provide block diagrams of a single antenna receiver using the MRC process of FIG. 2 versus a multiple antenna receiver using the MRC process of FIG. 2.

FIG. 10 provides a block diagram of a system performing a first step in a calibration process using the MRC process of FIG. 2.

FIG. 11 provides a second step of a calibration process using the MRC process of FIG. 2.

FIG. 12 provides a timing diagram of a protocol exchange for an exemplary embodiment using the MRC process of FIG. 2.

FIG. 13 provides a block diagram of an exemplary embodiment of a calibration packet using the MRC process of FIG. 2.

FIG. 14 provides a block diagram of a calibration signal loaded in a payload section using the MRC process of FIG. 2, the subcarriers having been demuxed and sent out on separate antennas.

### 5. DETAILED DESCRIPTION

Disclosed herein are various embodiments of transmission calibration systems and methods. Embodiments of a calibration technique calibrate a transmit antenna array of a radio (also referred to as a transceiver herein) using assistance from at least one other radio in the network. The other assisting radio in the network is used to examine a packet in a transmitted signal and to report the phase error of the transmit antenna array. One system embodiment comprises a processor that calibrates for phase errors introduced in the transmission and reception of signals. The calibration may be done in any type of processor such as a PHY layer processor, though not limited to a PHY layer processor, including, but not limited to, a digital signal processor (DSP), a microprocessor (MCU), a general purpose processor, and an application specific integrated circuit (ASIC), among others.

A new standard is being proposed, referred to as IEEE 802.11n (the “802.11n proposal”), which is a high data rate extension of the 802.11a standard at 5 GHz. It is noted that, at the present time, the 802.11n proposal is only a proposal and is not yet a completely defined standard. Other applicable standards include Bluetooth, xDSL, other sections of 802.11, etc.

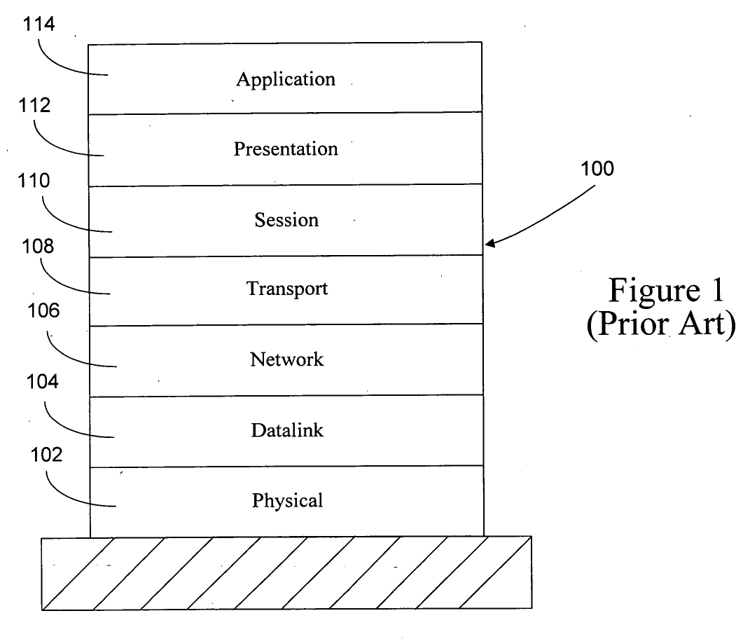

IEEE 802.11 is directed to wireless LANs, and in particular specifies the MAC and the PHY layers. These layers are intended to correspond closely to the two lowest layers of a system based on the ISO Basic Reference Model of OSI, i.e., the data link layer and the physical layer. FIG. 1 shows a diagrammatic representation of an open systems interconnection (OSI) layered model 100 developed by the International Organization for Standards (ISO) for describing the exchange of information between layers in communication networks. The OSI layered model 100 is particularly useful for separating the technological functions of each layer, and thereby facilitating the modification or update of a given layer without detrimentally impacting on the functions of neighboring layers.

At a lower most layer, the OSI model 100 has a physical layer or PHY layer 102 that is responsible for encoding and decoding data into signals that are transmitted across a particular medium. Above the PHY layer 102, a data link layer 104 is defined for providing reliable transmission of data over a network while performing appropriate interfacing with the PHY layer 102 and a network layer 106. The network layer 106 is responsible for routing data between nodes in a network, and for initiating, maintaining and terminating a communication link between users connected to the nodes. A transport layer 108 is responsible for performing data transfers within a particular level of service quality. A session layer 110 is generally concerned with controlling when users are able to transmit and receive data. A presentation layer 112 is responsible for translating, converting, compressing and decompressing data being transmitted across a medium. Finally, an application layer 114 provides users with suitable interfaces for accessing and connecting to a network.

Exemplary embodiments of the calibration techniques for a transmitter antenna array can be processed in a PHY signal processor. A PHY signal processor is configured to perform functionality of the preferred embodiments. A digital communication system may comprise such a processor, alone, or in combination with other logic or components. A system of communications may further be embodied in a wireless radio, or other communication device. Such a communication device may include many wireless communication devices, including computers (desktop, portable, laptop, etc.), consumer electronic devices (e.g., multi-media players), compatible telecommunication devices, personal digital assistants (PDAs), or any other type of network devices, such as printers, fax machines, scanners, hubs, switches, routers, set-top boxes, televisions with communication capability, etc. A Media Access Controller (MAC) Protocol enables the exchange of calibration information between radios. An assisting receiver helps calibrate a designated beam-forming transmitter by receiving a special transmit packet that can be transmitted and received by a radio for measurement of the phase errors from the transmit antenna. In general, transmit antennas have associated phase errors. To adjust for these phase errors in an MRC system (also referred to as a beam-forming system), described below, an assisted calibration technique is employed in which other transceivers in a network aid a designated transceiver by using a protocol to enable information sharing.

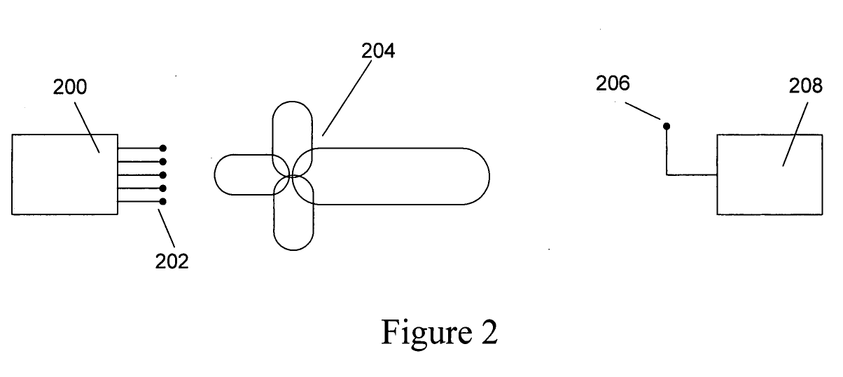

FIG. 2 provides a block diagram of transmit MRC in which a signal is focused at a designated receiver. Beam-forming transmitter 200 includes several transmit antennas 202. By phase aligning transmit signals 204 properly the signal can be focused in one designated direction. If the receiver 208 with antenna 206 is in a different location, the antennas adjust the phase to focus toward the new position of the receiver. This process can be called transmitter array phasing.

To enable transmitter array phasing, the beam-forming transmitter determines the phase differences between the transmit antennas. The exact phase difference of the antennas is inconsequential; the relative phase difference is one focus of the calibration technique.

In general, phase errors can be introduced in the transmission system in several ways. The antennas 202 of the beam-forming transmitter 200 have natural phase delay related to the hardware. These shifts are unknown. When hardware, such as capacitors, inductors, and the antenna array 202 itself, are used, a phase delay is introduced, creating a phase shift in the signal. These phase shifts can be unknown and uncontrolled. However, when multiple signals are created in the beam-forming transmitter 200, an intentional phase shift can be sent to each antenna 202. For example, in a beam-forming transmitter 200 with two transmit antennas 202 focused at a designated receiver, beam-forming transmitter 200 sends the same signal on both antennas but applies a phase difference between the two. By varying that phase difference in the signal processor, the direction of the signals can be altered.

This phase difference can be measured by an assisting receiver. In the non-limiting example of two transmit antennas the receiver expects the two signals coming into the receiver antenna to be completely phase aligned, coherent. To establish a corrective phase difference, a calibration packet is transmitted by a beam-forming transmitter that allows the assisting receiver to discern the individual phases of each individual antenna.

A calibration packet may have a special construct through which the receiver processes the incoming packet and measures the phase differences of the antennas. An assisting receiver and a beam-forming transmitter go through a handshaking process and the receiver indicates the phase differences to the beam-forming transmitter. Then the beam-forming transmitter and assisting receiver drop back into a normal operational mode. In this embodiment, the assisting receiver uses existing circuitry to process the calibration packet.

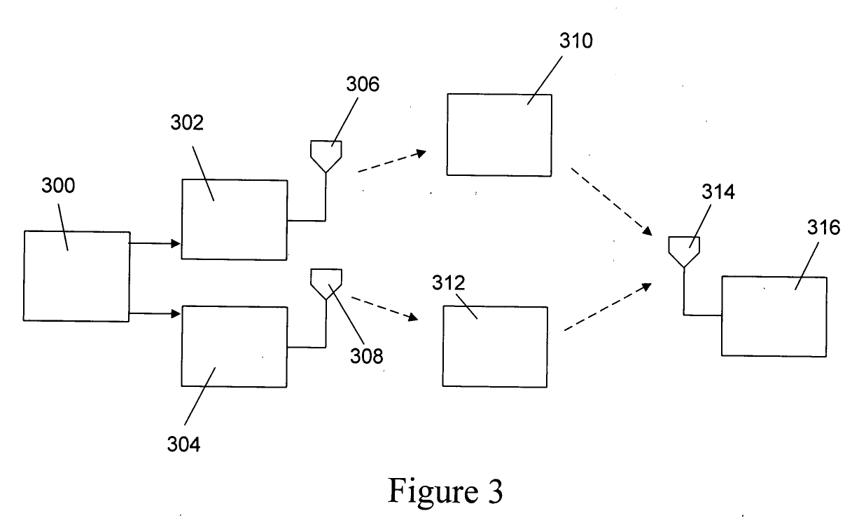

FIG. 3 provides a block diagram of the phase errors introduced throughout a transmit path. The phase errors associated with a first antenna 306 and a second antenna 308 are represented in association with blocks 302, 304, respectively. These phase errors are related to factors including the cabling, the coax, antennas, amplifiers, etc. that are associated with the antennas, and the phase errors can differ between the two antennas 306, 308. There are also phase errors 310, 312 related to the path the transmit signal takes to the receiver. Additionally, the receiver 316 itself has phase errors associated with it. All of these errors associated with blocks 302, 304, 310, 312, 316 can be measured in the assisting receiver and compensated for in the beam-forming transmitter with a single adjustment.

Once the beam-forming transmitter knows the phase differences of the path from the beam-forming transmitter to the receiver, the beam-forming transmitter can intentionally apply a compensating phase shift in a signal processor associated with the transmitter. For example, if there is a 30 degree phase shift between the two signals transmitted from a beam-forming transmitter when it reaches the end of a receive chain, the assisting receiver notifies the beam-forming transmitter of this phase error, and the beam-forming transmitter can intentionally apply a negative 30 degree phase shift. The negative 30 degree phase shift combined with the plus 30 degrees phase shift associated with the hardware of the beam-forming transmitter and assisting receiver, and the multi-path leads to a composite phase error of substantially zero degrees.

In one embodiment, the calibration technique as described above is applied such that it not only compensates for a phase shift caused by the transmission of the signal, but it also compensates for any phase shift in the receive circuitry. So, the calibration technique improves the receiver sensitivity as well. The more antennas that are used to beam-form the signal, the higher the energy and the sharper the directivity pattern the beam-forming transmitter can effectively generate.

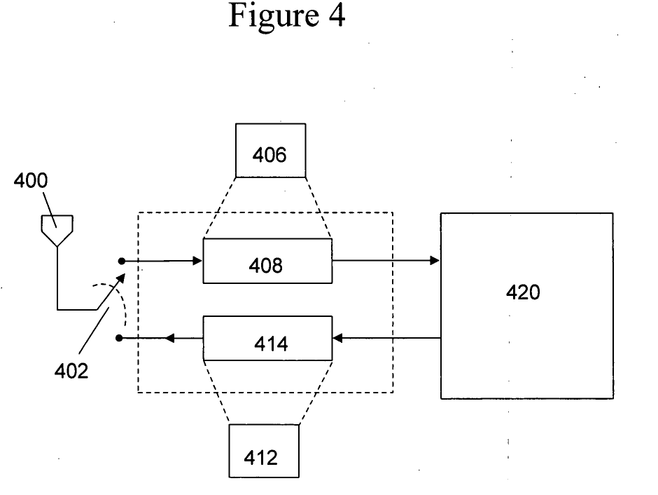

FIG. 4 provides a block diagram of an exemplary embodiment of a radio, which is also referred to herein as a transceiver. Element 400 is an antenna. Element 402 is a switch which switches the antenna between the receiver and the transmitter. Element 408 is a receive chain which has associated phase error 406. Element 414 is a transmit chain with associated phase error 412. Element 420 is a baseband processor. In one embodiment, the radio transmits using a time division multiple access (TDMA) protocol. The radio transmits for a set period, and then flips to a receive mode for a set period, each set period depending on the frequency and setup of the designated TDMA protocol. Antenna 400 is switched between the transmit path 414 and the receive path 408 by switch 402. In general, receive path 408 has phase shift 406 that is different than phase shift 412 of transmit path 414. Processor 420 effectuates the calibration technique.

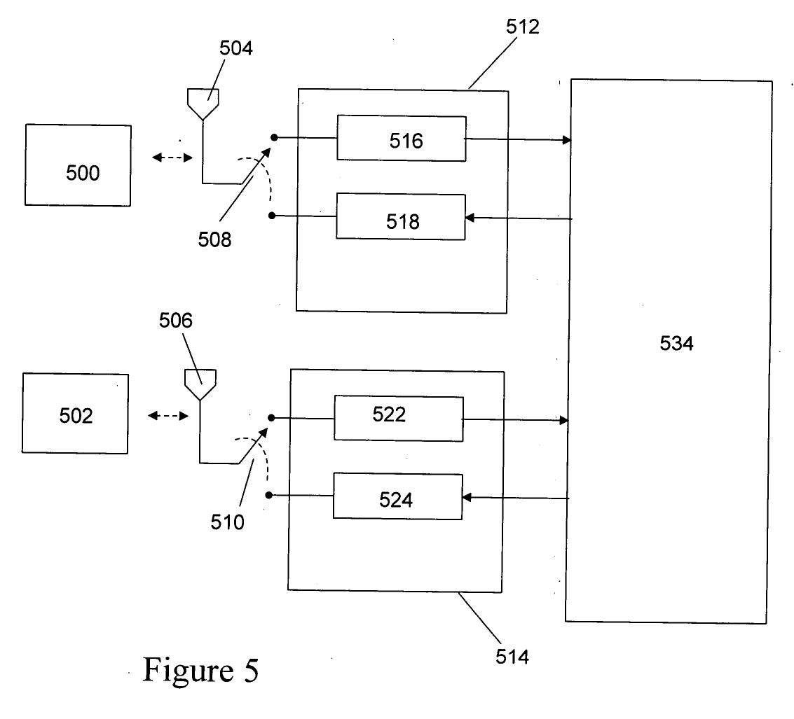

In regards to calibration, there are generally two types of radios: one (type 1) transmits and receives on the same set of antennas, and the other (type 2) transmits on one set of antennas and receives on another set. A type 1 radio uses a more sophisticated over-the-air calibration technique incorporating reciprocal properties of the multipath channel and antenna array. When a type 1 radio transmits a packet, it also receives a packet on that same exact channel frequency using a TDMA protocol. FIG. 5 is a block diagram of an exemplary embodiment of a type 1 radio. Element 500 is a first transmission channel with associated phase error. Element 504 is an antenna. Element 508 is a switch which switches the antenna between receiver 516 and transmitter 518 of first transceiver module 512. Element 502 is a second transmission channel with an associated phase error. Element 506 is an antenna. Element 510 is a switch which switches the antenna between receiver 522 and transmitter 524 of second transceiver module 514. Element 534 is a baseband processor. Each antenna 504, 506 has a corresponding transceiver module 512, 514. Antenna 504 is switched by switch 508 between receiver 516 and transmitter 518. At the same time, antenna 506 is switched by switch 510 between receiver 522 and transmitter 524.

If the radio is in the receive time slot, it uses its multiple antennas 504, 506 to receive. If it is in the transmit time slot, it flips the switch 508, 510 to the transmit mode and turns off its receiver 516, 522, usually, to save power. The same antenna 504, 506 is used for both transmitting and receiving for each respective transceiver module 512, 514. Since the receivers 516, 522 and transmitters 518, 524 of each transceiver module 512, 514 use a single antenna, the channel 500, 502 with accompanying phase shift is common for each transmitter and receiver pair 512, 514. The receiver channel phase dynamics match the transmit channel phase dynamics. Phase dynamics occur with movement (e.g., moving around, driving in a car, etc.). Since the channel phase shifts are common, only the phase difference due to the transmit and receive chains need to be calibrated. The nature of the transmit and receive chain phase characteristics is such that they vary slowly, and generally, only due to temperature variation. The reciprocal nature of a type 1 radio corresponds to using the same antenna such that, a signal is transmitted in the same direction from which the received signal came.

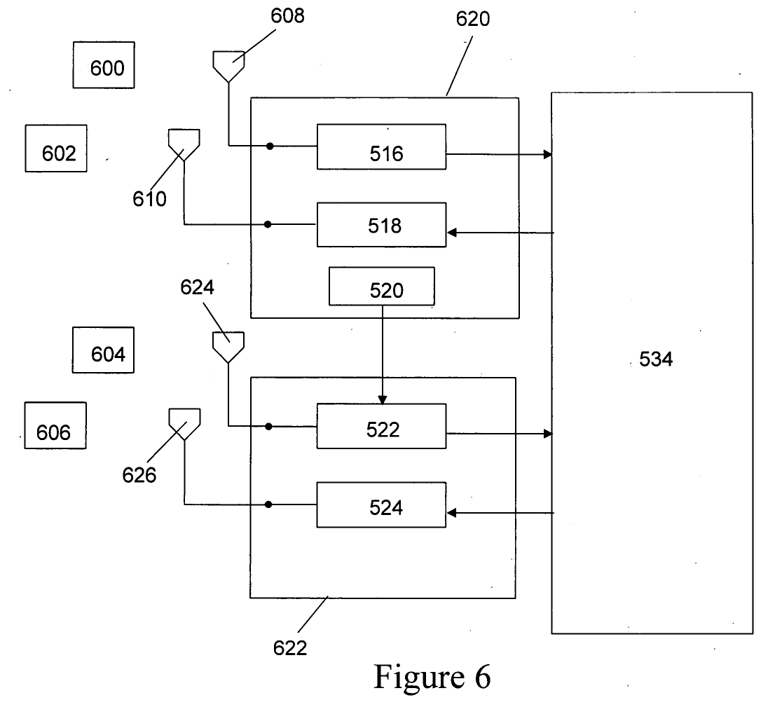

FIG. 6 provides a block diagram of a type 2 radio, which uses different antennas for transmitting and for receiving. One difficulty with the type 2 radio is that the beam-forming transmitter cannot use receive phase information to transmit a signal in the same direction from which the receive signal came. Additionally, the radio does not know the relationship between the transmit antennas and the receive antennas. A type 2 radio also cannot exploit the channel reciprocity of a type 1 radio. However, the type 2 radio can still be calibrated. In a type 2 radio, receive channel phase shifts 600, 604 from a signal received at corresponding receive antennas 608, 624 are not related in any way to transmit channel phase shifts 602, 606 from a signal transmitted at corresponding transmit antennas 610, 626. The remaining circuitry of the type 2 radio is the same as in the type 1 radio of FIG. 5.

Since the channel phase shift may not be constantly remeasured for calibration in the type 1 radio, a type 1 radio can be calibrated much less frequently than a type 2 radio. Since the type 2 radio is not aware of the relationship between the transmit and receive antennas, the type 2 radio does not know how to focus the energy to the receiver. With the type 2 radio, the calibration algorithm is performed more regularly to calibrate the phase errors due to a change in the channel characteristics, which can be very computationally intensive.

The type 1 and type 2 radios calibrate in the same manner. However, the type 2 is recalibrated regularly, whereas the type 1 radio is recalibrated seldom, corresponding to phase changes due primarily to temperature drift. To enable the calibration, a custom calibration packet, introduced in the preamble of the packet, is transmitted by the beam-forming transmitter. The assisting receiver can measure the phase difference using the custom calibration packet. Once the assisting receiver measures the phase difference by receiving the custom calibration packet, the assisting receiver then tells the beam-forming transmitter what the phase shift was. By sending the packet back, the assisting receiver is telling the beam-forming transmitter what that information was. To measure the phase difference, the beam-forming transmitter sends the custom calibration packet in a custom way for a training period, which helps the assisting receiver measure the phase differences. Once the phase differences are determined using the calibration packet, the assisting receiver just reports back the resulting measurement.

In a type 2 radio, the configuration of the phases for a receive packet from a designated radio have no direct relationship to the configuration of the phases necessary for beam-forming transmitter calibration. For example, a type 2 radio may have a receive antenna on the front side of the radio, and a transmit antenna on the back side of the radio. When the radio receives a packet from one direction, it would naturally transmit back in the same direction. However, in reality, a preferred strategy may be, in this case, to transmit in a different direction and bounce off a wall, to reach the intended target. A disjoint relationship exists in this spatial arrangement of the antennas.

Type 2 radios may use different frequencies for transmitting and receiving. A type 2 radio transmits on one set of frequencies with a transmit antenna array and receives on a different set of frequencies with a receive antenna array. In a type 1 radio, however, transmit and receive channels use the same frequency. Type 2 radios are full-duplex and type 1 radios are half-duplex. Type 2 has an advantage of avoiding lossy switches at the antennas. So, as detailed earlier, the overall phase error introduced in a wireless LAN signal transmission includes the phase shifts in the beam-forming transmitter, the phase shifts in the channel, and phase shifts in the assisting receiver.

An exemplary embodiment of the calibration technique employs an OFDM symbol of the IEEE 802.11 wireless LAN protocol called the long sync signal. In an 802.11 OFDM signal there are 52 subcarriers stacked together containing both training and data information. To help an assisting receiver determine the phase difference between two received signals, for the first OFDM symbol, all the even subcarriers are transmitted from a first antenna of a beam-forming transmitter and all the odd subcarriers are transmitted from a second antenna of the beam-forming transmitter. Then, for the next OFDM symbol, the subcarriers are swapped such that the even subcarriers are sent off the second antenna of a beam-forming transmitter and the odd subcarriers are sent off of the first antenna of the beam-forming transmitter. The assisting receiver examines the phase differences for each subcarrier corresponding to each antenna for one OFDM symbol and then compares that to the phase differences of the subcarriers for the next OFDM symbol. In this manner, the OFDM signal is used as a training signal.

By transmitting half the subcarriers off one antenna of a beam-forming transmitter and half off the other during the calibration period, potential collisions between subcarriers received at an assisting receiver are avoided. If the same subcarrier sequence is sent at the same time off both antennas of the beam-forming transmitter, they may interfere with each other. By demuxing the subcarriers into an even/odd swapping pattern, potential interference problems from the multiple transmit antennas are reduced. When a data mode is begun, the interference is desirable. It is desirable to transmit the same subcarrier off multiple antennas, phase aligned so that they constructively interfere at the assisting receiver, creating beam-forming.

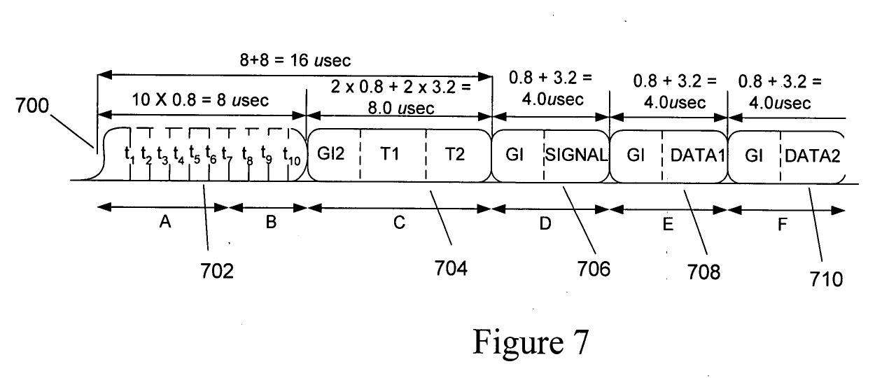

FIG. 7 provides a timing diagram of an IEEE 802.11 packet 700. The long sync 704 is a known fixed pattern at the front end of the preamble used for channel estimation—training an assisting receiver to estimate the multipath channel. A short sync 702 symbol is transmitted first followed by long sync symbol 704 and data symbols 706, 708, and 710. Long sync symbol 704 is a fixed OFDM sub carrier pattern known by the assisting receiver. By measuring the received subcarrier it can estimate the phase shift created by the multipath. The fixed long sync pattern 704 is used to allow assisting radios to measure the phase difference of the antennas.

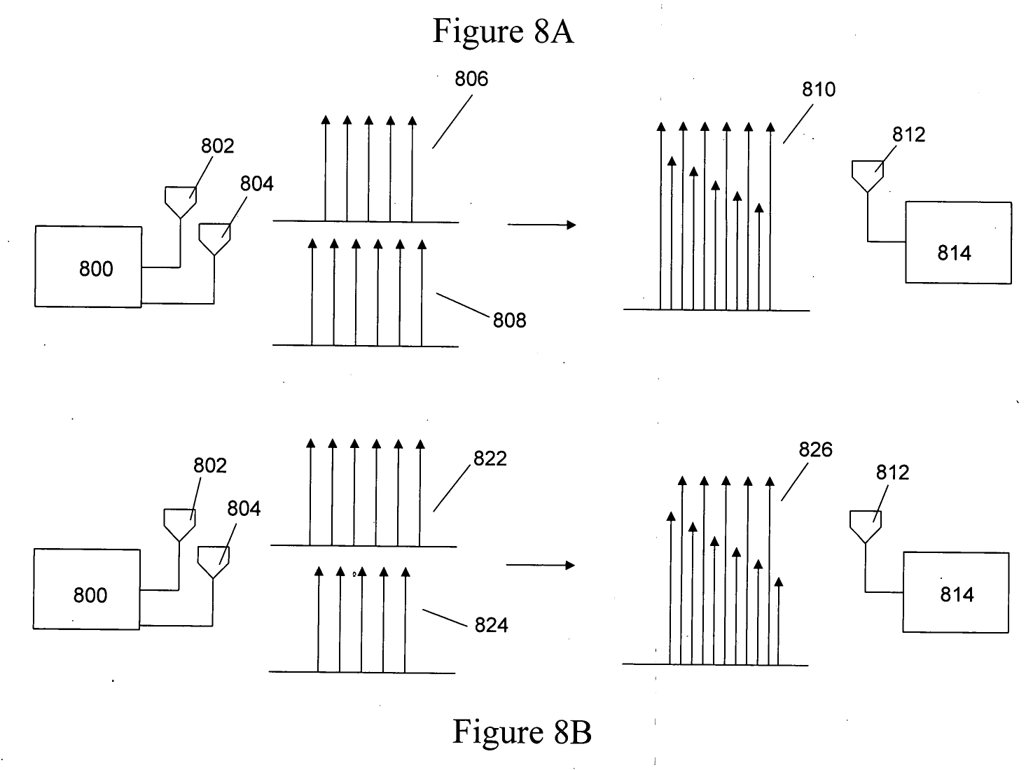

FIGS. 8A and 8B provide block diagrams of an exemplary embodiment of a demuxing technique from beam-forming transmitter 800. First, in FIG. 8A, in a first calibration signal, even subcarriers 806 are sent off antenna 802 and odd subcarriers 808 are sent off antenna 804. In FIG. 8B, for the second calibration signal, the subcarriers are swapped. Odd subcarriers 822 are sent off antenna 802 and even subcarriers 824 are sent off antenna 804. By demuxing the subcarriers and sending consecutive subcarriers on different antennas, there is no interference for any particular receive symbol during the calibration period. The multipath coming off antennas 802 and 804 can radically differ. Since antennas 802, 804 of an array of antennas of the beam-forming transmitter 800 are spatially located at different positions, signals transmitted from antennas 802, 804 bounce off of objects differently. When the signals 810, 826 arrive on antenna 812 at assisting receiver 814, reflecting versions of the packet have different configurations. With two antennas 802, 804 there is fully different spatial signature. Assisting receiver 814 determines the phases of the even and odd subcarriers for the first signal 810 and then determines the phases of the even and odd subcarriers for the second signal 826. Then assisting receiver 814 compares the phase difference between what was received on the first signal 810 and what was received on the second-signal 826. The phase difference is reported back to beam-forming transmitter 800. Beam-forming transmitter 800 now has an indication of the phase error that was observed at the assisting receiver 814 and that phase error can be compensated in later transmissions such that there is no phase error.

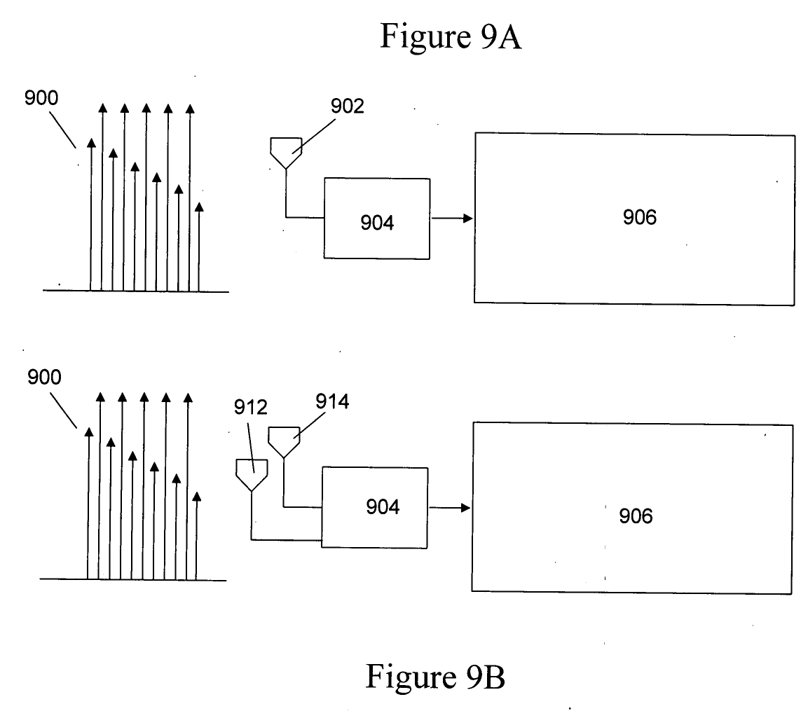

FIGS. 9A and 9B provide block diagrams comparing a single antenna receiver versus a multiple antenna receiver, respectively. The multiple antenna receiver system of FIG. 9B provides increased reliability in the phase error measurement. In FIG. 9A, demuxed signal 900 is received on single antenna 902 for reception by assisting receiver 904. Block 906 is a processor that measures the average difference between the odd and even subcarriers from the training signals 900. In FIG. 9B, demuxed signal 900 is received on dual antennas 912, 914 for reception by assisting receiver 904. Now, processor 906 has twice as much data to average, so a more precise phase error can be calculated. Thus, a multiple antenna receiver is more accurate than a single antenna receiver.

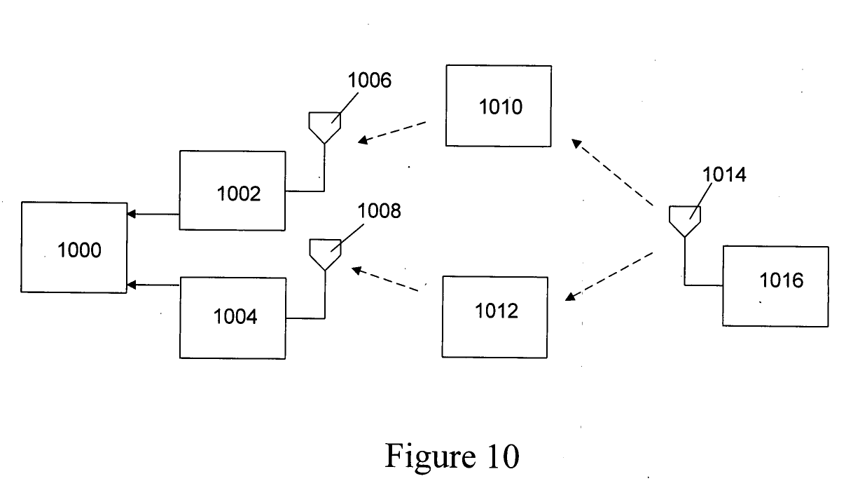

FIG. 10 provides a block diagram of a system that performs the first step in the calibration process for type 1 radios. Beam-forming transmitter 1016 transmits a signal off antenna 1014 over a transmission channel. In this exemplary embodiment, the transmit packet is a conventional IEEE 802.11a or IEEE 802.11g OFDM packet. The transmit packet is not a custom calibration packet. Each transmission channel transmission has a multipath channel 1010, 1012 with corresponding phase shift associated with it, depending on several factors, including, but not limited to, the physical surroundings. As the signals are received on antennas 1006, 1008, each signal has a phase shift associated with each respective assisting receiver front end 1002, 1004. The assisting receiver 1000 then aggregates these three errors (transmit front end phase shift 1016; multipath phase shift 1010, 1012; and receive front end phase shift 1002, 1004) into a composite phase shift “P” as perceived by the receive processor. It is not necessary to know which errors were attributed to which stage, or by what proportion. The composite phase shift is compensated for by calibrating the beam-forming transmitter to achieve substantially zero phase shift in a beam-formed signal.

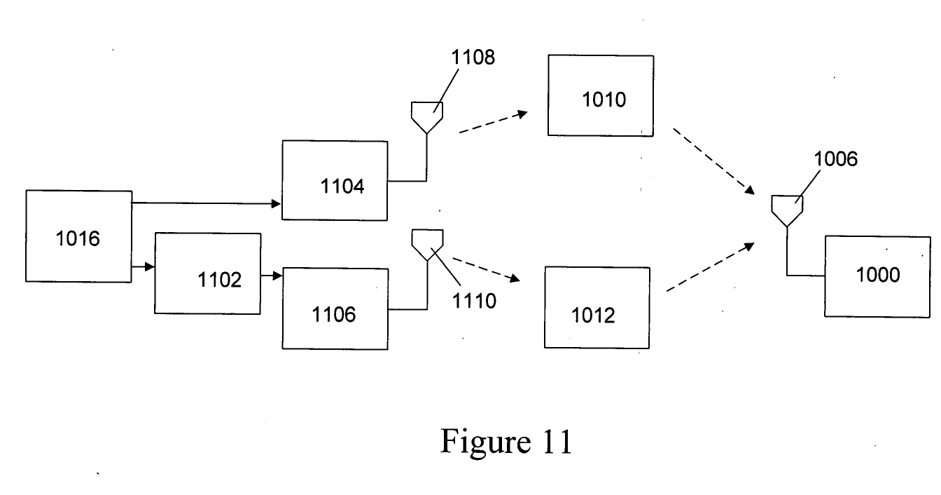

FIG. 11 provides the second step of the calibration process. For step 2, the beam-forming transmitter 1016 transmits the custom calibration packet back to assisting receiver 1000. The beam-forming transmitter beam-forms the calibration packet using the reciprocal phase information received in step 1. The assisting receiver 1000 then measures any calibration errors that may exist and reports back the result. After the assisting receiver sends the composite phase error P back to beam-forming transmitter 1016, beam-forming transmitter 1016 introduces a phase shift 1102 of the negative phase angle -P corresponding to the composite phase error. So the phase error received at assisting receiver 1000 on antenna 1006 consists of front end phase shift 1104 and 1106, transmitted from antennas 1108 and 1110 respectively, channel phase shifts 1010 and 1012, and phase shift corresponding to the assisting receiver 1000 (which aggregate to P) plus the introduced phase shift -P. This results in a calibrated phase shift of substantially zero.

In an exemplary embodiment, a clear-to-send-to-self (CTS-to-self) packet is used to schedule a calibration period. The CTS-to-self is a special packet that clears the network for a period of time. The CTS-to-self tells any radio in the network to shut down for a predetermined duration, because certain radios of interest are going to be using the channel medium for that period of time. Then, once the calibration period is scheduled, a time period is set to calibrate, and the calibration process is begun.

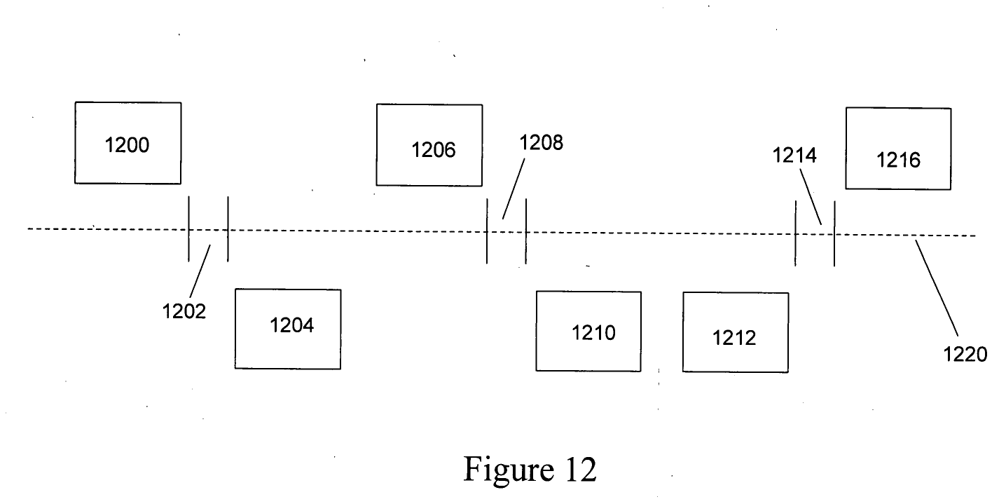

FIG. 12 provides a timing diagram of a protocol exchange for an exemplary embodiment. Timing for a radio in need of calibration is shown above time line 1220 and timing for the assisting radio is shown below time line 1220. In time period 1200, a frame is sent to the assisting station initiating the calibration. The assisting station sends back an acknowledgement packet in time period 1204 (see FIG. 10). The gap 1202 between time period 1200 and time period 1204 is a short interframe spacing (SIF). This gap 1202 between time periods in this exemplary embodiment is defined by the IEEE 802.11 specification. Time periods 1208 and 1214 are also SIFs. When the acknowledgement packet is received by the radio needing calibration, the phase error of the incoming packet is measured. The radio needing calibration beam-forms its transmission and sends it to the assisting radio in time period 1206 (see FIG. 11). The assisting radio measures the phase differences, and immediately responds with an acknowledgement in time period 1210. After computing the phase differences that it saw, it reports back the phase error during response time period 1212. To conclude, in time period 1216, the calibrating radio sends an acknowledgement that it successfully received the information.

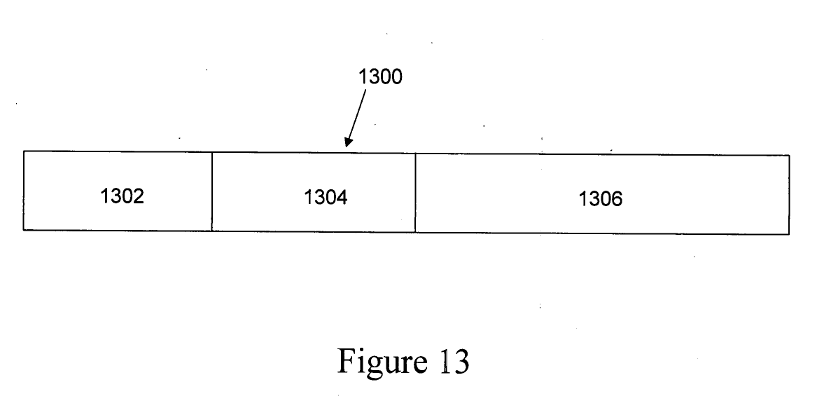

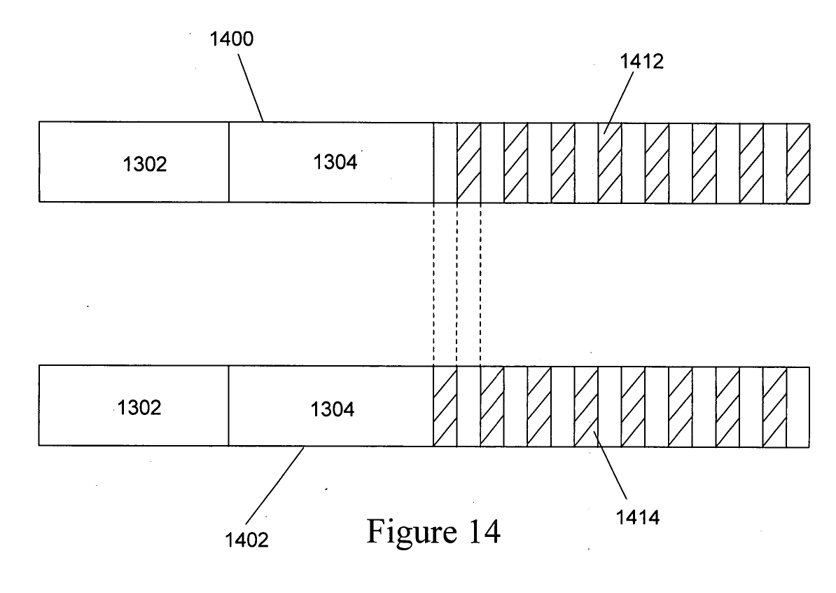

FIG. 13 provides a block diagram of an exemplary embodiment of the calibration packet 1300. This is only one particular way to implement the calibration packet 1300. One of ordinary skill in the art would know that there are several ways to implement the protocol and that this is but one exemplary protocol. An OFDM packet 1300 with preamble 1302 and a signal field 1304 is modified such that the payload 1306 contains the calibration signal. FIG. 14 provides two calibration signals 1400, 1402 having been demuxed with the even subcarriers loaded in payload section 1412 and the odd subcarriers loaded in payload section 1414. Signals 1400 and 1402 are sent out on two separate transmit antennas, swapping between the even and odd subcarriers on the first and second antenna for every other OFDM symbol.

While various embodiments of the invention have been described, it will be apparent to those of ordinary skill in the art that many more embodiments and implementations are possible that are within the scope of this invention.

What is claimed is:

1. A method of communications comprising:
transmitting a signal from a device with a first antenna array; and
calibrating the signal with a phase shift of the signal.

2. The method of claim 1, further comprising:
receiving a calibration signal;
wherein calibrating with a phase shift of the first antenna array is based at least in part on the received calibration signal.

3. The method of claim 2, wherein the calibration signal is received in a preamble of a signal modulated using Orthogonal Frequency Divisional Multiplexing (OFDM).

4. The method of claim 1, further comprising:
periodically recalibrating with a phase shift of the signal if the device receives an incoming signal on a second antenna array that is separate from the first antenna array.

5. A method for managing wireless local area network (LAN) communications comprising:
defining an OFDM signal pattern of subcarriers comprising a preamble training structure, the preamble training structure comprising a sync pattern including a calibration symbol for calibrating with a phase shift of a signal and a data pattern; and
transmitting the signal pattern.

6. The method of claim 5, wherein the sync pattern including the calibration symbol is a long sync pattern.

7. The method of claim 5, wherein the subcarriers are demultiplexed sequentially to a plurality of transmit antennas.

8. A wireless radio comprising:
an array of antennas; and
a processor configured to prepare a signal for transmission using the array of antennas and to calibrate with a phase shift of the signal.

9. The radio of claim 8, wherein the array of antennas comprises directional antennas for directing the transmission of the signal to a receiver.

10. The radio of claim 8, wherein the processor is further configured to:
receive a calibration signal; and
calibrate with a phase shift of the signal based at least in part on the received calibration signal.

11. The radio of claim 10, wherein the processor is configured to receive the calibration signal in a preamble of a signal modulated using Orthogonal Frequency Divisional Multiplexing (OFDM).

12. The radio of claim 8, wherein at least one antenna of the array of antennas both transmits signals and receives signals.

13. The radio of claim 8, wherein at least one antenna of the array of antennas either transmits signals or receives signals.

14. The radio of claim 8, wherein the processor is further configured to periodically recalibrate the phase shift of the signal.

15. A system for wireless local area network communications comprising:
an array of antennas; and
a processor configured to prepare a signal for transmission using the array of antennas and to calibrate with a phase shift of the signal.

16. The system of claim 15, wherein the antennas of the array comprise directional antennas for directing the transmission of a signal to a receiver.

17. The system of claim 15, wherein the processor is further configured to:
receive a calibration signal; and
calibrate with a phase shift of the signal corresponding to the received calibration signal.

18. The system of claim 17, wherein the processor is configured to receive the calibration signal in a preamble of a signal modulated using Orthogonal Frequency Divisional Multiplexing (OFDM).

19. The system of claim 15, wherein an antenna of the array of antennas both transmits signals and receives signals.

20. The system of claim 15, wherein an antenna of the array of antennas either transmits signals or receives signals.

21. The radio of claim 15, wherein the processor is further configured to periodically recalibrate the phase shift of the signal.
